(19) United States
(12) Patent Application Publication
(10) Pub. No.: US 2022/0195722 A1
(43) Pub. Date: Jun. 23, 2022

(54) SOUND INSULATION TILE FOR BUILDING AND METHOD OF MANUFACTURING THE SAME

(71) Applicant: Isotech Products Incorporated, Jubei City (TW)

(72) Inventor: Hwang-Pao LEE, Jubei City (TW)

(21) Appl. No.: 17/556,320

(22) Filed: Dec. 20, 2021

(30) Foreign Application Priority Data
Dec. 23, 2020 (TW) 109145776

(51) Int. Cl. E04B 1/86; E04F 15/20; B32B 7/12

(52) U.S. Cl. CPC E04B 1/86; E04F 15/203; E04B 1/90; B32B 2307/102; B32B 7/12

(57) ABSTRACT

A sound insulation tile having a tile body and a sound insulation layer on a back surface of the tile body and used for buildings and a method of manufacturing the same are revealed. The sound insulation layer is made of unfoamed or foamed PU material containing special substances. A method of manufacturing sound insulation tiles includes the steps of preparing a plurality pieces of sound insulation layer whose size matches size of a tile body and then attaching the sound insulation layer to a back surface of the tile body by an adhesive layer. Another method of manufacturing sound insulation tiles includes the steps of coating thick PU material over a back side of a tile body to form an even sound insulation layer integrated with the tile body, and then curing the sound insulation layer for mass production of the sound insulation tile.

### BACKGROUND OF THE INVENTION

### Field of the Invention

The present invention relates to a tile and a method of manufacturing the same, especially to a sound insulation tile for buildings and a method of manufacturing the same.

### Description of Related Art

Along with urbanization, people usually live is a multi-family building. Most building code have stricter requirements for insulation performance of the wall or floor of the building in order to protect life quality of residents in the respective families. For example, the requirement or standard is for airborne sound insulation expressed by a single value, Rw, impact sound insulation of floors (Ln,w), reduction of transmitted impact noise by floor covering on floors (ΔLw), total area density or dynamic rigidity (s′). In order to meet the above requirements without changing material or structural of the wall/or floor of the building, the following techniques available now are used to address the issue of poor sound insulation of the building. (1) Use fake wood flooring which is made of plastic, usually polyvinyl chloride (PVC) with wood grain appearance. A layer of sound insulation material is attached to a back side of the fake wood flooring and then applied to the floor for improving sound insulation. Yet the fake wood flooring has the issue related to plasticizer evaporation and the surface of the plastic is difficult to show the gloss and texture of real wood. These shortcomings affect the market competitiveness of the product. (2) Pave insulation material with a thickness of at least 5-8 mm, semi-dry sand paste with a thickness of 50 mm, and tiles directly on the floor in turn. However, the floor load is increased and the sand paste as well as the files may have cracks due to different coefficients of thermal expansion. Moreover, most of tiles used now focus on aesthetic and lightweight design, unable to meet the requirements for sound insulation. Thus there is room for improvement and there is a need to provide a tile with novel design for sound insulation.

### SUMMARY OF THE INVENTION

Therefore, it is a primary object of the present invention to provide a sound insulation tile for buildings, which includes a tile body and a sound insulation layer disposed on a back surface of the tile body. The sound insulation layer is made of unfoamed material or foamed material, both formed by polyurethane (PU) material containing special substances which includes trifunctional polyether polyol, graft copolymers of trifunctional polyether polyol, difunctional polyether polyol, isocyanate, filling agent, suspending agent, and catalyst for better sound insulation performance.

In order to achieve the above object, a sound insulation tile for buildings according to the present invention includes a tile body and a sound insulation layer. The tile body is made of ceramic material, porcelain material, stone-like material, or glass material. The sound insulation layer is arranged at a back surface of the tile body and made of unfoamed or foamed body formed by polyurethane (PU) material containing special substances. When the sound insulation layer is made of unfoamed PU material, the PU material is composed of trifunctional polyether polyol, graft copolymers of trifunctional polyether polyol, difunctional polyether polyol, isocyanate, filling agent, suspending agent, dehydration agent, and catalyst. When the sound insulation layer is made of foamed PU material, the PU material includes trifunctional polyether polyol, graft copolymers of trifunctional polyether polyol, difunctional polyether polyol, isocyanate, filling agent, suspending agent, foaming agent, dehydration agent, and catalyst.

Preferably, the PU material used in the sound insulation layer includes 0-60 weight percentage (wt %) trifunctional polyether polyol, 0-60 wt % graft copolymers of trifunctional polyether polyol, 0-50 wt % difunctional polyether polyol, 3-30 wt % isocyanate, 0-50 wt % filling agent, 0-5 wt % suspending agent, 0-1 wt % foaming agent, 0-3 wt % dehydration agent, and 0-2 wt % catalyst.

Preferably, 0-10 wt % dehydration agent is further added during forming process of the sound insulation layer.

Preferably, the PU material used in the sound insulation layer consist of 8.8 weight percentage (wt %) trifunctional polyether polyol, 12 wt % graft copolymers of trifunctional polyether polyol, 24 wt % difunctional polyether polyol, 20 wt % isocyanate, 32 wt % filling agent, 0.8 wt % suspending agent, 0.24 wt % catalyst, and 2.16 wt % dehydration agent.

Preferably, the filling agent includes calcium carbonate, calcium silicate, calcium sulfate, barium sulfate, quartz powder, iron oxides, plastic powder, rubber powder, fiber powder, recycled fiber and various types of inorganic materials. The catalyst includes various types of organometallic compounds and various types of amine compounds. The dehydration agent consists of molecular sieve, Zeolite, monofunctional isocyanate, and chemical substances capable of reacting with water. The isocyanate includes toluene diisocyanate, hydride of toluene diisocyanate, toluene diisocyanate prepolymer, diphenyl methylene diisocyanate, hydride of diphenyl methylene diisocyanate, diphenyl methylene diisocyanate prepolymer, hexamethylene diisocyanate, hexamethylene diisocyanate prepolymer, isophorone diisocyanate, and isophorone diisocyanate prepolymer.

Preferably, a thickness of the sound insulation layer is ranging from 1 to 8 mm and a density of the sound insulation layer is 300-2000 kilogram (kg) per cubic meter.

Preferably, the sound insulation layer can be made of soft material or semi-hard material. When the sound insulation layer is made of semi-hard material, a hardness of the sound insulation layer is 15°-98° Shore A.

It is another object of the present invention to provide a method of manufacturing sound insulation tiles for buildings which includes the following steps. Providing a plurality pieces of tile body and a plurality pieces of sound insulation layer. Each tile body has a preset length and a preset width while a length and a width of the sound insulation layer are corresponding to the length and the width of the tile body respectively. Then arranging an adhesive layer between the respective pieces of the tile body and the respective pieces of the sound insulation layer to adhere each other and integrate into one part. Thereby a plurality pieces of sound insulation tile are mass produced.

It is a further object of the present invention to provide a method of manufacturing sound insulation tiles which includes the following steps. First providing a plurality pieces of tile body and thick polyurethane (PU) material used for forming a sound insulation layer. Then coating a back side of the respective pieces of the tile body with the thick PU material evenly to form the sound insulation layer having even thickness and integrated with the pieces of the tile body. Next drying and curing the sound insulation layer. Thereby a plurality pieces of sound insulation tile are mass produced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is an exploded view of the embodiment in FIG. 1 according to the present invention;

FIG. 3 is a schematic drawing showing an embodiment of a method of manufacturing sound insulation tiles according to the present invention;

FIG. 4 is a schematic drawing showing a dried and cured sound insulation layer being cut by a cutting tool of an embodiment according to the present invention;

FIG. 5 is a schematic drawing showing the sound insulation layer of the embodiment in FIG. 4 already cut according to the present invention;

FIG. 6 is a perspective view of another embodiment according to the present invention;

FIG. 7 is an exploded view of the embodiment in FIG. 6 according to the present invention;

FIG. 8 is a schematic drawing showing sound insulation tiles being attached to a surface of a wall or a floor of buildings according to the present invention;

FIG. 9 is a schematic drawing showing sound insulation tiles each of which is provided with an adhesive layer and attached to a surface of a wall or a floor of buildings according to the present invention.

### DETAILED DESCRIPTION OF THE PREFERRED EMBODIMENTS

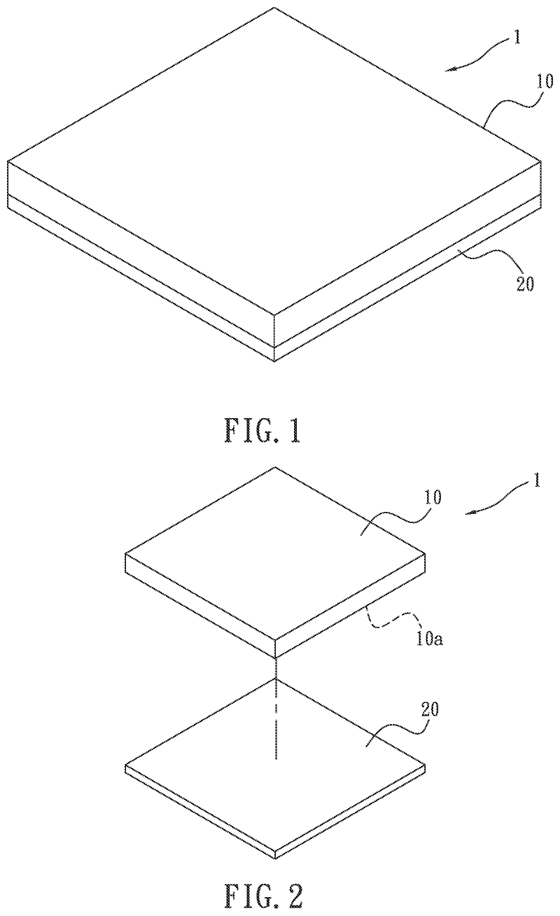

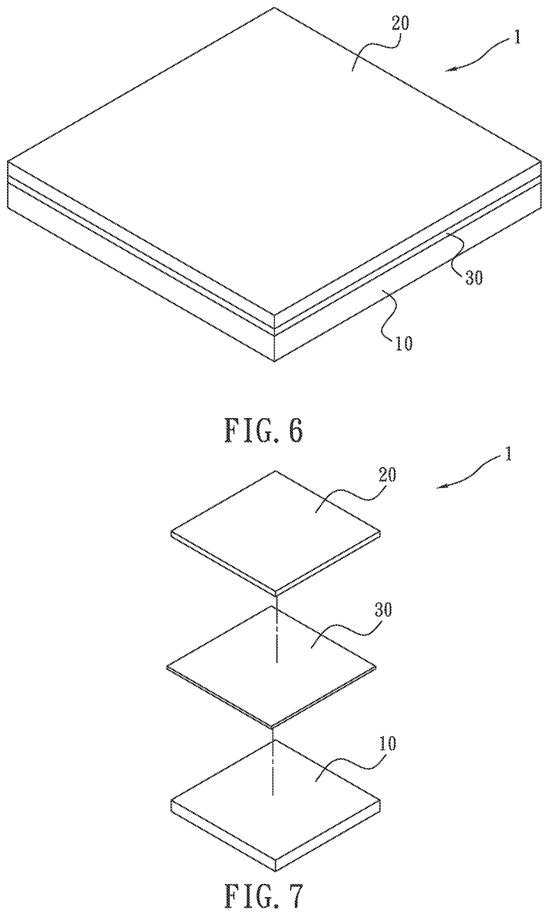

Refer to FIG. 1, FIG. 2, FIG. 6, and FIG. 7, a sound insulation tile 1 for buildings according to the present invention includes a tile body 10 and a sound insulation layer 20. The tile body 10 is made of ceramic material, porcelain material, stone-like material, or glass material.

The sound insulation layer 20 is disposed on a back surface 10a of the tile body 10 and made of unfoamed or foamed body formed by polyurethane (PU) material containing special substances, as shown in FIG. 2. When the sound insulation layer 20 is made of unfoamed body, the PU material is composed of trifunctional polyether polyol, graft copolymers of trifunctional polyether polyol, difunctional polyether polyol, isocyanate, filling agent, suspending agent, dehydration agent, and catalyst. When the sound insulation layer 20 is made of foamed body, the PU material includes trifunctional polyether polyol, graft copolymers of trifunctional polyether polyol, difunctional polyether polyol, isocyanate, filling agent, suspending agent, foaming agent, dehydration agent, and catalyst.

A thickness of the sound insulation layer 20 is ranging from 1 to 8 mm (but not limited) while a density of the sound insulation layer 20 is 300-2000 kilogram (kg) per cubic meter (but not limited) for meeting more requirements at manufacturing end. The sound insulation layer 20 can be a soft or semi-hard body. When the sound insulation layer 20 is a semi-hard body, hardness of the sound insulation layer 20 is 15°-98° Shore A, but not limited.

The PU material used in the sound insulation layer 20 further includes 0-60 weight percentage (wt %) trifunctional polyether polyol, 0-60 wt % graft copolymers of trifunctional polyether polyol, 0-50 wt % difunctional polyether polyol, 3-30 wt % isocyanate, 0-50 wt % filling agent, 0-5 wt % suspending agent, 0-1 wt % foaming agent, 0-3 wt % dehydration agent, and 0-2 wt % catalyst. Moreover, 0-10 wt % dehydration agent is further added during forming process of the sound insulation layer 20.

In a preferred embodiment, the PU material used in the sound insulation layer 20 includes 8.8 weight percentage (wt %) trifunctional polyether polyol, 12 wt % graft copolymers of trifunctional polyether polyol, 24 wt % difunctional polyether polyol, 20 wt % isocyanate, 32 wt % filling agent, 0.8 wt % suspending agent, 0.24 wt % catalyst and 2.16 wt % dehydration agent.

The filling agent includes calcium carbonate, calcium silicate, calcium sulfate, barium sulfate, quartz powder, iron oxides, plastic powder, rubber powder, fiber powder, recycled fiber and various types of inorganic materials. The catalyst includes various types of organometallic compounds and various types of amine compounds. The dehydration agent consists of molecular sieve, Zeolite, monofunctional isocyanate, and chemical substances capable of reacting with water. The isocyanate includes, but not limited to, toluene diisocyanate, hydride of toluene diisocyanate, toluene diisocyanate prepolymer, diphenyl methylene diisocyanate, hydride of diphenyl methylene diisocyanate, diphenyl methylene diisocyanate prepolymer, hexamethylene diisocyanate, hexamethylene diisocyanate prepolymer, isophorone diisocyanate, and isophorone diisocyanate prepolymer.

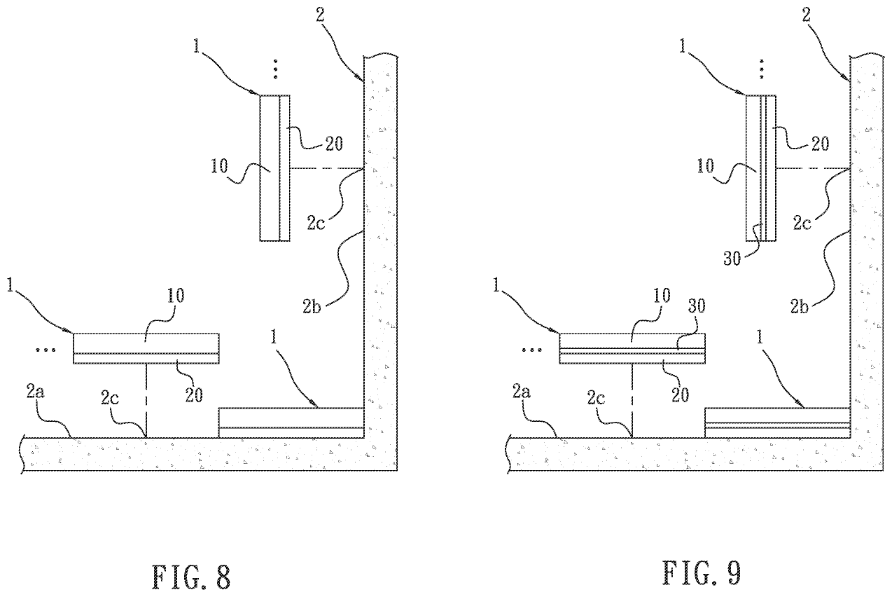

While in use, the sound insulation tile 1 are attached to a surface 2c of at least one wall 2b or at least one floor 2a of a building 2, as shown in FIG. 8 and FIG. 9. After the wall 2b or the floor 2a being paved with the sound insulation tiles 1, a layer of waterproof coating is coated on a surface of the tile body 10 of the sound insulation tile 1. Then a layer of surface protection material is further disposed over the surface of the tile body 10 of the sound insulation tile 1 for protecting and extending the service life of the sound insulation tile 1.

Refer to FIG. 6 and FIG. 7, a first method of manufacturing sound insulation tiles 1 according to the present invention includes the following steps.
(a) Providing a plurality pieces of tile body 10 each of which has a preset length and a preset width;
(b) Providing a plurality pieces of sound insulation layer 20 each of which has a length and a width thereof corresponding to the length and the width of the tile body 10 respectively;
(c) Providing a type of adhesive material which includes, but not limited to, an adhesive or a sticker.
(d) Using the adhesive material to form an adhesive layer 30 between the respective pieces of the tile body 10 and the respective pieces of the sound insulation layer 20 so that the respective pieces of the tile body 10 and the respective pieces of the sound insulation layer 20 are integrated by the adhesive layer 30 to form a plurality of pieces of sound insulation tile 1.

Refer to FIG. 1-5, a second method of manufacturing sound insulation tiles 1 according to the present invention includes the following steps.

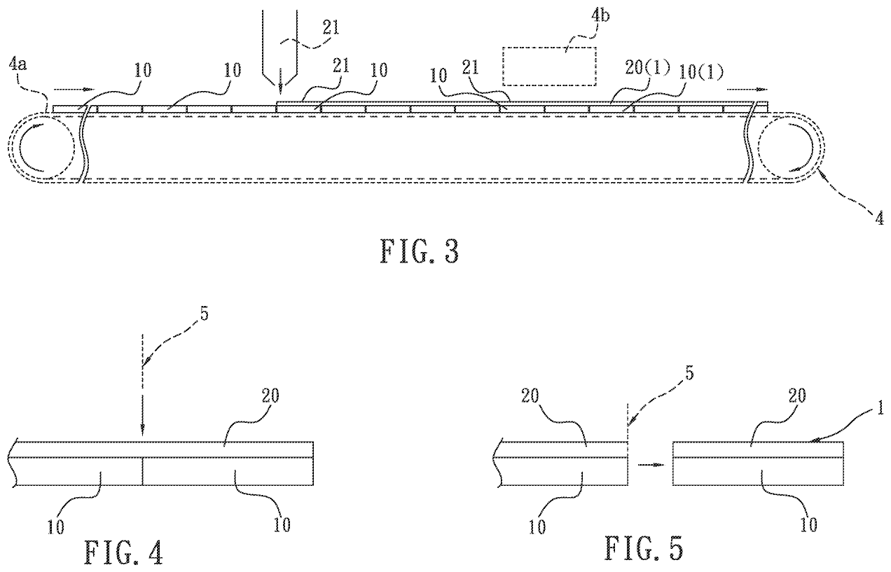

(a) Providing a plurality pieces of tile body 10;
(b) Providing thick polyurethane (PU) material 21 which is used to form a sound insulation layer 20; and
(c) Coating a back side of the pieces of the tile body 10 with the thick PU material 21 evenly to form the sound insulation layer 20 on the back side of the pieces of the tile body 10 and integrate with each other to form one part. Refer to FIG. 3, a circulating conveyor 4 is provided. The circulating conveyor 4 is provided with a closed-loop loading surface 4a circulating from a front end to a rear end thereof for continuous transport and at least one drying curing area 4b arranged at the transport path between the front end and the rear end thereof. The respective pieces of the tile body 10 are disposed on the circulating loading surface 4a with the back facing up and then the sticky PU material 21 is evenly coated on the back side of the tile body 10 continuously from the front end of the circulating conveyor 4. Later the respective pieces of the tile body 10 reach the rear end of the circulating conveyor 4 and come off the circulating conveyor 4, as shown in FIG. 3.
(d) Drying and curing the sound insulation layer 20. A cutting tool 5 is further provided, as shown in FIG. 4 and FIG. 5. The respective sound insulation layers 20 are cut by the cutting tool 5 after being dried and cured, as shown in FIG. 5. Thereby a plurality of sound insulation tiles 1 are mass-produced.

In summary, the present sound insulation tile 1 has the following advantages:

(1) Owing to the sound insulation layer 20 which is made of unfoamed or foamed PU material containing special substances, the present sound insulation tile 1 provides better sound insulation performance in use than conventional sound insulation material or sound insulation techniques available now.
(2) By the first method of manufacturing the sound insulation tiles 1, the respective tile bodies 10 and the respective sound insulation layers 20 are mass-produced in factories of different manufacturing ends. Then the respective tile bodies 10 and the respective sound insulation layers 20 are transported to the construction site to be attached to each other and applied on site. Thus both manufacturing and on-site application of the sound insulation tile are more convenient.
(3) By the second method of manufacturing the sound insulation tiles 1, the tile body 10 (or the sound insulation layer 20) can be directly mass-produced to form the sound insulation tiles 1 in the factories at the manufacturing end. Then the sound insulation tiles 1 are transported to the construction site to be used. Thus both manufacturing and on-site application of the sound insulation tile are more convenient.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A sound insulation tile for buildings comprising:
a tile body which is made of a material selected from ceramic material, porcelain material, stone-like material, and glass material;
an sound insulation layer which is disposed on a back surface of the tile body and made of unfoamed body or foamed body formed by polyurethane (PU) material;
wherein when the sound insulation layer is made of unfoamed body, the PU material is composed of trifunctional polyether polyol, graft copolymers of trifunctional polyether polyol, difunctional polyether polyol, isocyanate, filling agent, suspending agent, dehydration agent, and catalyst;
when the sound insulation layer is made of foamed body, the PU material includes trifunctional polyether polyol, graft copolymers of trifunctional polyether polyol, difunctional polyether polyol, isocyanate, filling agent, suspending agent, foaming agent, dehydration agent, and catalyst.

2. The sound insulation tile as claimed in claim 1, wherein the PU material for the sound insulation layer includes 0-60 weight percentage (wt %) trifunctional polyether polyol, 0-60 wt % graft copolymers of trifunctional polyether polyol, 0-50 wt % difunctional polyether polyol, 3-30 wt % isocyanate, 0-50 wt % filling agent, 0-5 wt % suspending agent, 0-1 wt % foaming agent, 0-3 wt % dehydration agent, and 0-2 wt % catalyst.

3. The sound insulation tile as claimed in claim 2, wherein during forming process of the sound insulation layer, dehydration agent is further added and ranging from 0 to 10 wt %.

4. The sound insulation tile as claimed in claim 3, wherein the PU material for the sound insulation layer further includes 8.8 weight percentage (wt %) trifunctional polyether polyol, 12 wt % graft copolymers of trifunctional polyether polyol, 24 wt % difunctional polyether polyol, 20 wt % isocyanate, 32 wt % filling agent, 0.8 wt % suspending agent, 0.24 wt % catalyst, and 2.16 wt % dehydration agent.

5. The sound insulation tile as claimed in claim 4, wherein the filling agent includes calcium carbonate, calcium silicate, calcium sulfate, barium sulfate, quartz powder, iron oxides, plastic powder, rubber powder, fiber powder, recycled fiber and various types of inorganic materials; wherein the catalyst includes various types of organometallic compounds and various types of amine compounds; wherein the dehydration agent consists of molecular sieve, Zeolite, monofunctional isocyanate, and chemical substances capable of reacting with water; wherein the isocyanate includes toluene diisocyanate, hydride of toluene diisocyanate, toluene diisocyanate prepolymer, diphenyl methylene diisocyanate, hydride of diphenyl methylene diisocyanate, diphenyl methylene diisocyanate prepolymer, hexamethylene diisocyanate, hexamethylene diisocyanate prepolymer, isophorone diisocyanate, and isophorone diisocyanate prepolymer.

6. The sound insulation tile as claimed in claim 1, wherein a thickness of the sound insulation layer is ranging from 1 to 8 mm; wherein a density of the sound insulation layer is 300-2000 kilogram per cubic meter.

7. The sound insulation tile as claimed in claim 1, wherein the sound insulation layer is a soft body or a semi-hard body; hardness of the sound insulation layer is 15°-98° Shore A when the sound insulation layer is the semi-hard body.

8. A method of manufacturing sound insulation tiles comprising the steps of:
(a) providing a plurality pieces of tile body each of which has a preset length and a preset width;
(b) providing a plurality pieces of sound insulation layer each of which has a length and a width thereof corresponding to the length and the width of the tile body respectively;
(c) providing an adhesive material; and
(d) using the adhesive material to form an adhesive layer between the pieces of the tile body and the pieces of the sound insulation layer so that the pieces of the tile body and the pieces of the sound insulation layer are integrated by the adhesive layer to form a plurality of pieces of sound insulation tile.

9. A method of manufacturing sound insulation tiles comprising the steps of:
(a) providing a plurality pieces of tile body;
(b) thick polyurethane (PU) material which is used to form a sound insulation layer;
(c) coating a back side of the pieces of the tile body with the thick PU material evenly to form the sound insulation layer on the back side of the pieces of the tile body and integrate with each other to form one part; and
(d) drying and curing the sound insulation layer to form a plurality pieces of the sound insulation tiles.

10. The method as claimed in claim 9, wherein a circulating conveyor is provided in the step (c); the circulating conveyor is provided with a closed-loop loading surface circulating from a front end to a rear end thereof for continuous transport and a drying curing area arranged at transport path between the front end and the rear end thereof; the pieces of the tile body are disposed on the circulating loading surface with the back facing up and then the back side of the pieces of the tile body is coated with the sticky PU material evenly and continuously from the front end of the circulating conveyor; then the pieces of the tile body reach the rear end of the circulating conveyor and come off the circulating conveyor.

11. The method as claimed in claim 9, wherein a cutting tool is provided in the step (d) for cutting the sound insulation layer after drying and curing.
